(19) United States
(12) Patent Application Publication
(10) Pub. No.: US 2010/0257104 A1
(43) Pub. Date: Oct. 7, 2010

(54) METHOD AND APPARATUS FOR REPAIR PROCEDURE

(76) Inventor: Reza BUNDY, Venice, CA (US)

Correspondence Address: DLA PIPER US LLP, 1999 AVENUE OF THE STARS, SUITE 400, LOS ANGELES, CA, 90067-6023, US

(21) Appl. No.: 12/754,531

(22) Filed: Apr. 5, 2010

Related U.S. Application Data
(63) Continuation-in-part of application No. 12/191,294, filed on Aug. 13, 2008.
(60) Provisional application No. 61/166,679, filed on Apr. 3, 2009.

(51) Int. Cl. G06Q 30/00; G06Q 10/00; G06Q 50/00

(52) U.S. Cl. 705/80; 705/305

(57) ABSTRACT

The system provides a method an apparatus for enabling a buyer or seller to easily obtain a mechanical inspection of a vehicle for sale. A seller may obtain an inspection and offer to make the inspection report available to all prospective purchasers prior to completion of the sale. In other instances, the inspection report may be offered to a potential buyer for a fee. In another embodiment, a sponsor may offer a free inspection in exchange for promotional messages associated with the vehicle. In another embodiment, a buyer may have the option to order an inspection on a vehicle for sale, either for a fee or in return for promotional or marketing efforts. In yet another embodiment, an inspection report of a vehicle for sale on the system may be distributed to mechanics and repair centers in the geographical areas of the buyer and/or the seller of a vehicle.

This is a continuation-in-part of U.S. patent application Ser. No. 12/191,294 filed on Oct. 27, 2008 entitled “Method and Apparatus for Implementing a Peer-to-Peer System” and assigned to the assignee of the present application. This patent application claims priority to U.S. Provisional Patent Application 61/166,679 filed Apr. 3, 2009 which is incorporated by reference herein in its entirety.

### BACKGROUND OF THE SYSTEM

There have been a number of system to allow peer to peer transaction of products and services. By peer to peer in this application we refer to non-commercial sales between individuals. One example of a peer to peer transaction is the purchase or sale of an automobile between an owner of the automobile and an individual. In the past this has involved the placing of classified advertisements in some media such as a newspaper, a used vehicle focused publication, or on the internet. Some transactions are implemented via auction sites such as eBay.

There are a number of disadvantages of prior art systems for implementing peer to peer transactions. On the seller side, problems include marketing, exposure to strangers, multiple contacts from buyers, unqualified buyers, unfamiliar paperwork, and long cycle times. On the buyer side, problems include connecting with the seller, unavailability of the vehicle, unknown level of trust in the condition of the vehicle, lack of commercial financing and insurance, and lack of clean title.

Another disadvantage of prior art systems is risk associated with purchasing a vehicle from a private party where the mechanical condition of the vehicle is unknown and potential problems with the vehicle are unknown, minimized, or not disclosed. Some buyers prefer to purchase used vehicles from a dealer so that there is someone to blame or to protest to if there is something wrong with the vehicle. It would be an advantage to provide a system where the mechanical condition of the vehicle can be known or discovered prior to purchase of the vehicle.

### SUMMARY OF THE SYSTEM

The system provides a method an apparatus for enabling a buyer or seller to easily obtain a mechanical inspection of a vehicle for sale. A seller may obtain an inspection and offer to make the inspection report available to all prospective purchasers prior to completion of the sale. In other instances, the inspection report may be offered to a potential buyer for a fee. In another embodiment, a sponsor may offer a free inspection in exchange for promotional messages associated with the vehicle. In another embodiment, a buyer may have the option to order an inspection on a vehicle for sale, either for a fee or in return for promotional or marketing efforts. In yet another embodiment, an inspection report of a vehicle for sale on the system may be distributed to mechanics and repair centers in the geographical areas of the buyer and/or the seller of a vehicle. The repair centers may competitively bid on repairs that are recommended in the inspection report. The system can present an interface where the buyer or seller can select a repair center through the system to undertake recommended repairs.

### BRIEF DESCRIPTION OF THE DRAWINGS

FIG. 1 is a flow diagram illustrating the functional operation of the system from the seller's viewpoint.

FIG. 2 is a flow diagram illustrating the operation of the profile step of the system.

FIG. 3 is an embodiment of a vehicle information entry system.

FIG. 4 is an example of a query to the seller in an embodiment of the system.

FIG. 5 is an example of data entry in one embodiment of the system.

FIG. 6 is an example of a price selection menu in an embodiment of the system.

FIG. 7 illustrates one embodiment of the number of options that a seller can choose for listing and advertising using the system.

FIG. 8 is a flow diagram illustrating an embodiment of the system where a potential buyer requests an inspection of a vehicle.

FIG. 9 is a flow diagram illustrating a self warranty operation in one embodiment of the system.

FIG. 10 is a flow diagram illustrating transaction completion in an embodiment of the system.

FIG. 11 is an example hardware embodiment of the system.

FIG. 12 is a flow diagram illustrating the operation of the repair flow of the system.

FIG. 13 is a flow diagram illustrating an embodiment of how to distribute the inspection report.

FIG. 14 is a flow diagram illustrating an embodiment of preparing a report for the buyer.

### DETAILED DESCRIPTION OF THE SYSTEM

The system provides a method and apparatus for the retrieval and normalization of third party listings. In the examples below, the system is described in connection with transactions involving automobiles. However, the system is not limited to such products and may be implemented with any goods and/or services without departing from the scope of the system.

The system provides useful tools for the seller, the buyer, and for completing the transaction. These tools and methods will be described below, followed by the description of the retrieval and normalization of third party listings.

Seller

We will initially describe the operation of the system from the standpoint of the seller. When a seller wishes to sell an automobile, the seller typically places an advertisement. This ad may be on the vehicle itself in the form of a placard, it may be posted publicly in a high traffic area such as a shopping center or busy street, it may be placed in a periodical such as a newspaper, it may be placed online, or it may be placed in any combination of the above. Another option for a seller is to use an online auction site, such as eBay, as a tool for selling the vehicle. A problem for the seller is not only choosing which medium in which to advertise the vehicle, but how to phrase the advertisement for maximum effect and how to price the vehicle properly for likely sale but adequate return.

Many sellers will rely on other ads that they have seen and attempt to copy an ad when marketing their own vehicle. In addition, a seller may rely on a third party valuation site, such as Kelly Blue Book (www.kbb.com) as a source for pricing information. Often the seller will overestimate or underestimate the condition and value of their vehicle and thus choose an in appropriate price that either delays or prevents sale, or costs the seller revenue.

The system automatically walks a seller through all the steps needed to market the vehicle in a professional manner that maximizes peer to peer sales potential. The system includes profiling of the vehicle, imaging, certification, listing and advertising, tracking and management, and buyer screening.

Operation of the System (Seller)

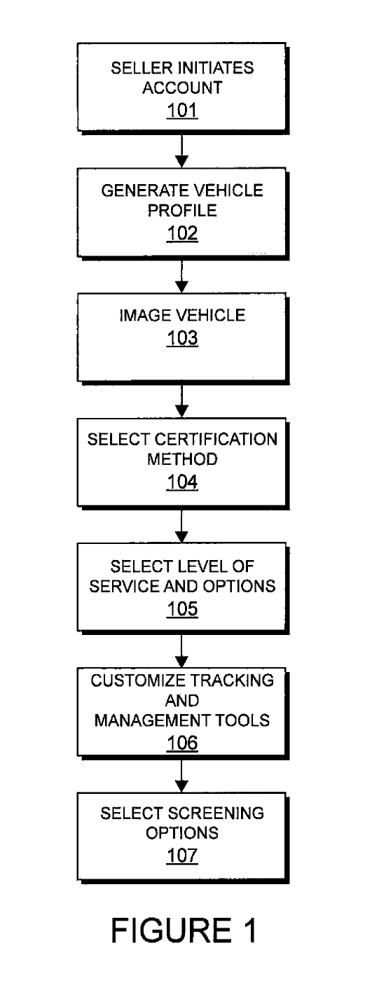

FIG. 1 is a flow diagram illustrating the functional operation of the system from the seller's viewpoint. At step 101 the seller signs up and creates an account in the system. At step 102 the vehicle profile is generated. In one embodiment of the system, the vehicle profile comprises a vehicle “biography” and a selling price. The system includes a method for aiding the seller in generating a biography that is useful for the particular vehicle and area where the vehicle is to be sold, and provides automatically generated information that allows the seller to intelligently price the vehicle.

At step 103 the system directs the seller to image the vehicle. This may be by uploading photographs of the vehicle or by requesting a service package where professional photographs are taken. Audio files, three-dimensional “virtual walkthroughs”, videos, and other types of vehicle imaging content may be uploaded as well. At step 104 the seller is prompted to select a certification method for the vehicle. This allows the seller to choose from a plurality of certification methods that have different pricing structures and may be initiated by the buyer instead of the seller. At step 105 the system presents selectable options associated with the level of service that the user has selected and includes choices for listing and advertising the vehicle. At step 106 the seller is given a chance to customize and select tracking and management tools. At step 107 the seller selects buyer screening options, including call center services.

Profile

Auto-Biogaphy

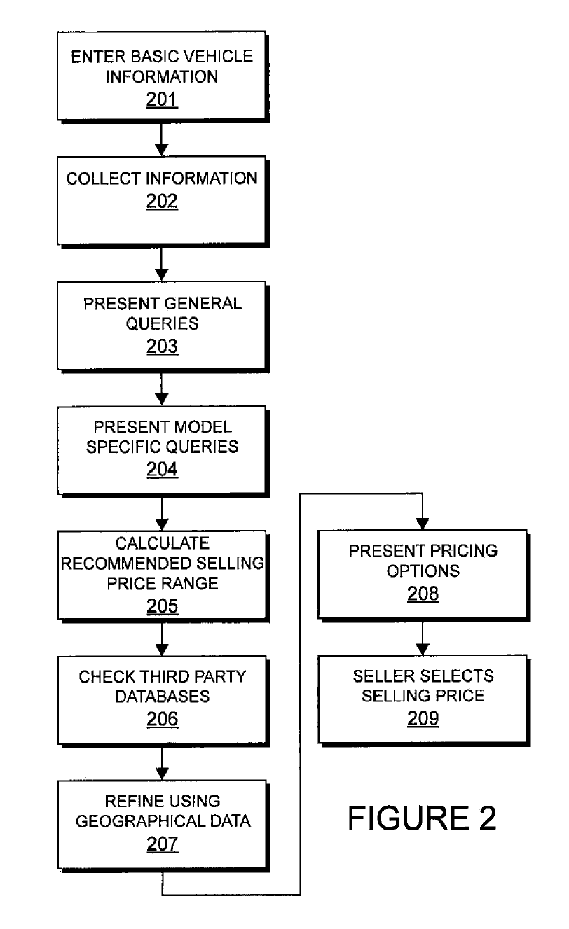

As noted above, the system prompts the user to profile the vehicle at step 102. This profile comprises a biography of the vehicle as well as selecting a selling price for the vehicle. FIG. 2 is a flow diagram illustrating the operation of the profile step of the system. At step 201 the seller enters basic information about the vehicle such as year, make, model and some other basic questions. This step collects information likely to be known by the seller that will assist in directing the seller in later steps of the process.

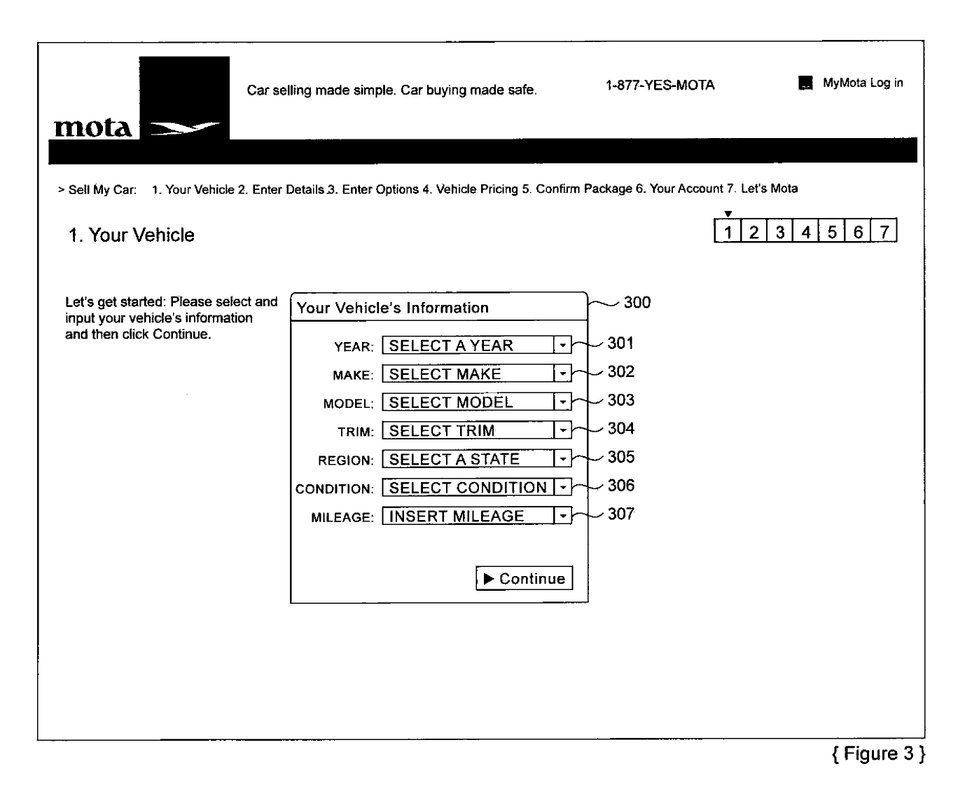

Referring briefly to FIG. 3, one embodiment of a vehicle information entry system 300 for implementing step 201 is illustrated. Here the seller chooses the year 301, make 302, and model 303 of the vehicle to be sold. In one embodiment, completion of the fields is done from top down, with each answer modifying lower fields so that appropriate choices are provided. For example, after the make 302 (e.g. Ford, Mercedes) is selected, the model menu 303 is populated only with models from that maker and made in the year selected at field 301. Similarly, the trim field 304 is populated only with options for that model of that year. The region (e.g. state) field 305 will affect later options presented to the seller as well (including some of the questions related to the biography of the vehicle as well as the price). The condition field 306 is often misunderstood by the seller but later questions that are customized for the vehicle aid in correctly describing the condition of the vehicle. Finally the seller enters the mileage 307 and proceeds to the next step.

Returning to FIG. 2, at step 202 the system collects the initial data entered by the seller in step 201 and retrieves a series of interactive queries for the seller that aid in providing more detail for the biography of the vehicle.

At step 203 the seller is presented with a series of general queries. In one embodiment, these questions are focused on the condition of the vehicle (interior, exterior, and mechanical), the everyday use of the vehicle, maintenance of the vehicle, extras, and a space for additional information that the seller may think is important.

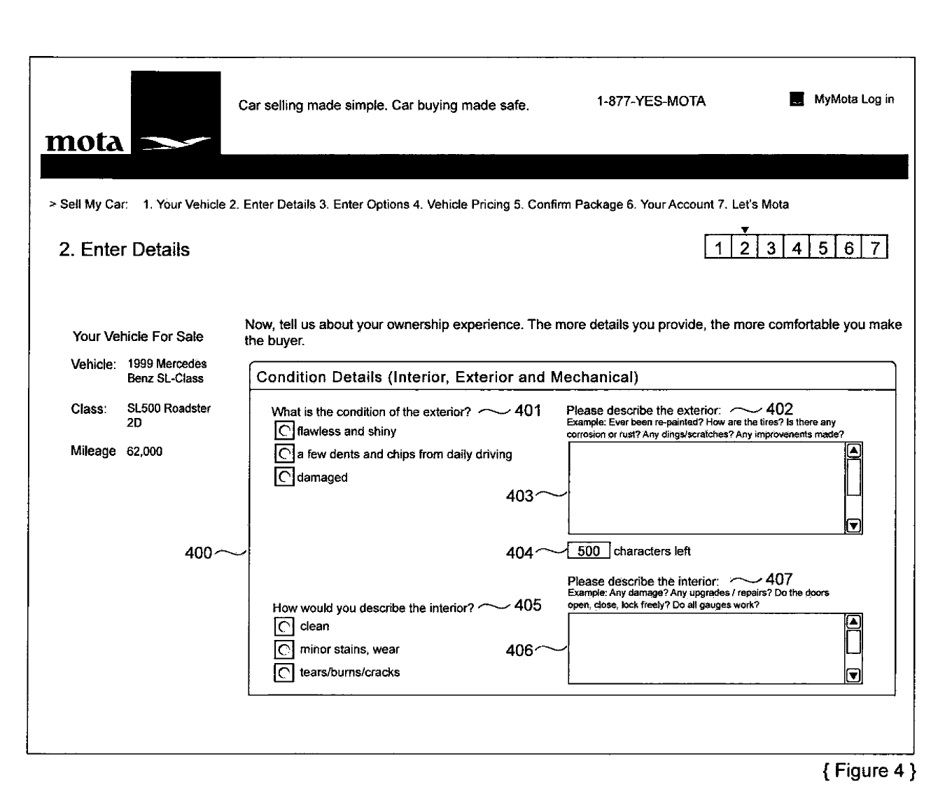

The system provides explanations of the queries and includes a text box where the seller can enter additional information as desired. Referring now to FIG. 4, and example of a query is illustrated. Query 400 relates to the condition of the vehicle exterior and interior. The seller is presented with three checkboxes 401 to generally describe the exterior of the vehicle. The user can simply select one of the boxes and proceed to the next query. Alternatively, the user can enter text into text box 403 to more fully describe the vehicle. This detail supplements (and possibly corrects) the choice of condition 306 selected in step 201.

The system provides helpful hints 402 about items that may be of interest. The seller can simply describe items of the vehicle that match up with the hints above a query box to provide a more useful biography of the vehicle. Alternatively, the seller can choose their own additional description if desired. In one embodiment, the system indicates how many characters the seller can still enter in the text box at box 404. In one embodiment, the system limits the amount of text the seller can enter as a method of keeping the vehicle biography more readable. The seller is presented with regions 405, 406, and 407 to indicate condition of the interior.

This system of guiding and directing the seller, as well as limiting the number of words, results in a vehicle biography that includes the kind of information that is useful to a buyer and/or in marketing a vehicle. Many times sellers do not know the kind or amount of information to include in a vehicle description, so the system removes the guesswork and uncertainty.

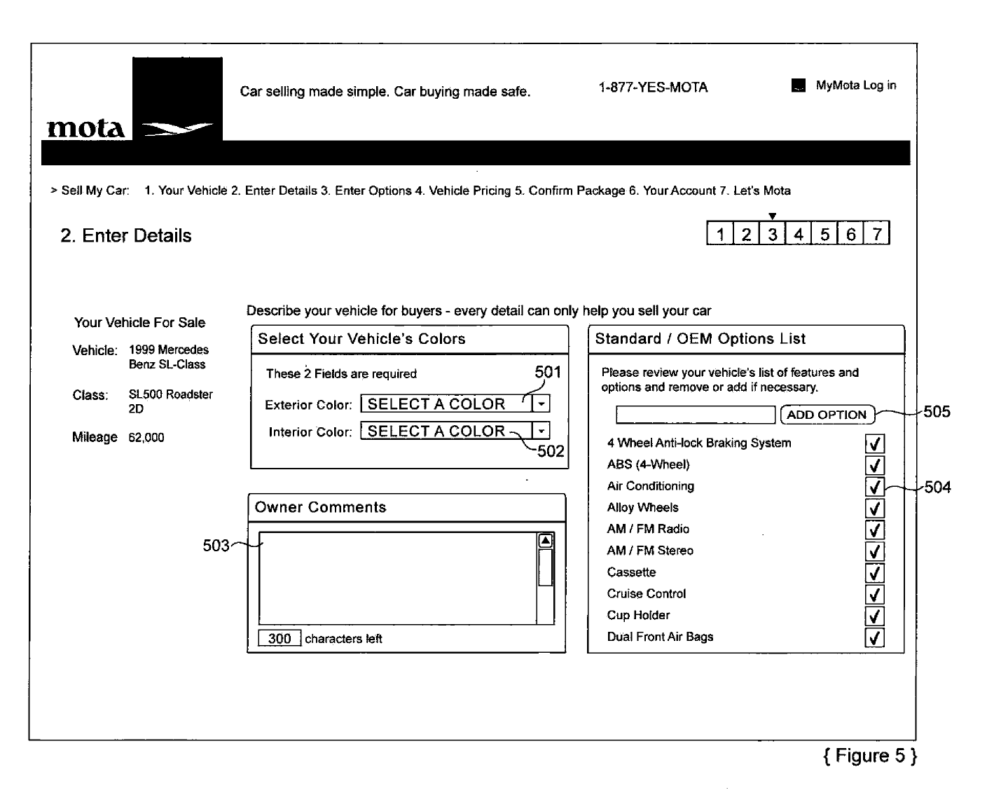

At step 204 the seller is presented with a series of queries that are specific to the year, make and model of the vehicle identified in step 201. Step 204 allows the user to specify certain descriptive features of the vehicle such as interior and exterior color, options, and any additional options or customizations that the vehicle may have. Referring briefly to FIG. 5, the system presents the user with data entry including required fields for exterior color 501 and interior color 502. If the color of the vehicle is not found in available colors of the pull down lists, the user can describe the color in text field 503. Region 504 lists the available options for the year, make, model, and trim level selected by the seller. The seller can de-select any of the options that do not apply and use field 505 to add options that may not be reflected in the list.

Pricing

At step 205 the system uses the data provided in the auto-biography to find a recommended price for the vehicle. The system checks third party databases at step 206. These databases can be sites such as Kelly Blue Book as well as eBay, on-line advertisements, or reported sales data from government resources. The system uses geographical data at step 207 to further customize the pricing algorithm. At step 208 the system provides the seller with pricing options. At step 209 the seller selects a price and confirms it to the system.

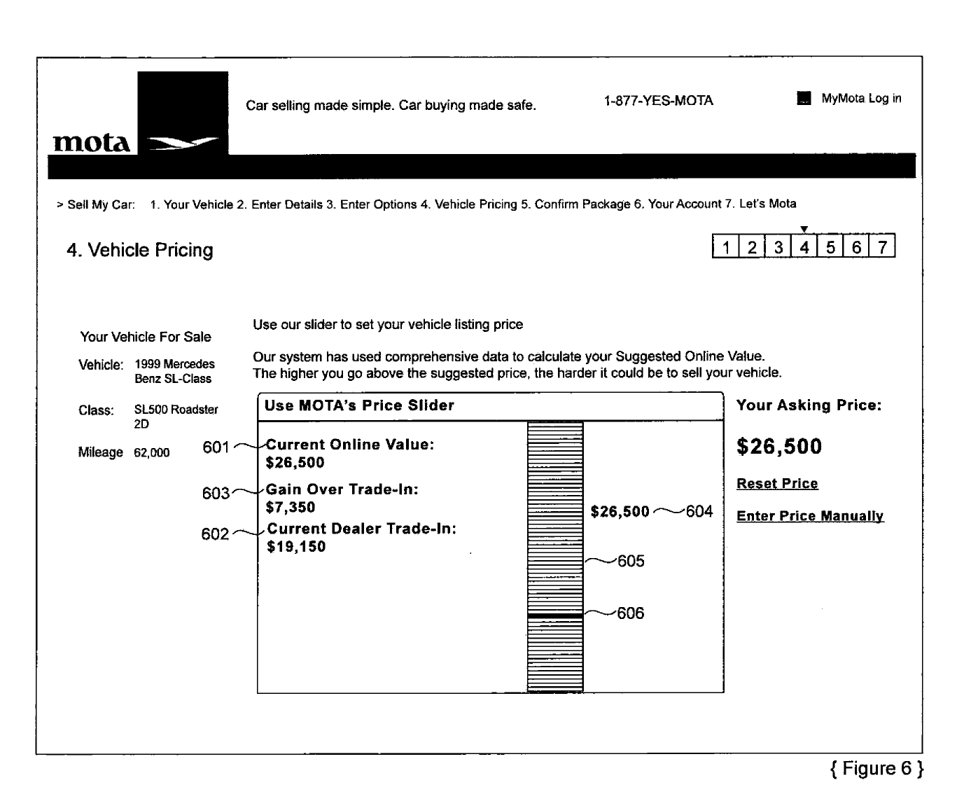

FIG. 6 is an example of a price selection menu in an embodiment of the system. The seller is presented with an estimated sales price 601 based on available data and vehicle profile. The current estimated trade-in value 602 is also provided. The system then provides the gain 603 of a peer-to-peer sale over a trade-in. This is useful information as it allows the seller to realize how flexible in the price to be while still achieving an advantage over simply trading in the vehicle. The menu allows the seller to grab the sales price slider 604 to the right of the bar 605 and simply move it up and down to set a selling price. The price displayed in the slider 604 changes automatically as the seller moves the slider 604 up and down. In addition, the gain value 603 is automatically recalculated as the slider moves so the seller can see how much of an advantage is achieved over trade-in for each new price.

A low price indicator bar 606 is defined on the slider scale to represent a minimum price below which the user should not consider setting the sales price. This minimum sales price is calculated by the system and is based on the profile information, location, time of year, and other relevant information, including the selling frequency of vehicles of that type and the number of competing vehicles of the same type or same category. It should be noted that the seller is free to set a sales price below that line 606 if desired. In addition, the user can manually enter a price instead of using the slider 604.

Imaging

The system provides the seller the ability to include images of the vehicle in the listings the user may choose. In one embodiment the system provides the option of the seller to take their own pictures or videos for use in the marketing of the vehicle. Optionally, the seller can optionally choose to have a professional third party photographer take images or videos of the vehicle. As will be seen below in Listing and Advertising, the number of images or videos that will accompany the vehicle depends on the selection by the seller of one of a plurality of listing options. Another embodiment of the system provides an option of the seller to take their own voice, record it over the telephone, and embed the generated audio clip in the marketing of the vehicle. Another embodiment of the system provides an option of the seller to upload videos or three-dimensional visualizations of the vehicle for use in the marketing of the vehicle.

Certification

One of the drawbacks in peer-to-peer sales is the lack of trustworthiness of the seller by the buyer. The buyer may have doubts about the actual condition of the vehicle and may not want to rely on the word of the seller. If there is a problem with the vehicle, the buyer may have no one to pursue to correct any problems or misrepresentations regarding the vehicle. This limitation can tend to lead the buyer to purchase from a commercial party such as a dealer so that some level of both trustworthiness or future liability can be had. For some buyers who wish to take advantage of peer-to-peer sales, one approach has been to have a trusted mechanic inspect the vehicle and report on condition and problems. This leads to inconvenience in arranging to have the vehicle provided to the mechanic and delays while the mechanic inspects the vehicle. Another problem is when the vehicle is at a distance from the buyer. The buyer may not be able to arrange for the vehicle to be delivered to a known mechanic and is then in the position of needing to find a mechanic in another town or city or even state to perform the inspection.

The system provides a number of solutions for problems associated with certification. In one embodiment, the seller may choose to have an inspection performed and then make the vehicle inspection report (VIR) available on-line as part of the listing. In another embodiment, the seller may have a VIR prepared but charge a nominal fee to view the VIR. This will tend to self select those viewing the VIR to more serious purchasers.

In another embodiment, the system provides information about a vehicle inspection service that the buyer can elect to use to have an inspection performed. This serves to further self select serious buyers. This is a step that would normally be taken by a serious buyer but is often made difficult by distance from the seller. By providing information about an inspection service as well as a published price for the inspection, the guesswork is removed on the part of the buyer. An advantage of this third party inspection is that it may include a warranty of some sort on the inspection (e.g. 30 days) that may give comfort to a buyer who otherwise would be wary of a peer-to-peer sale.

In one embodiment, the system has a relationship with a known national entity for the inspections. For example, the system may have a relationship with an entity such as Pep Boys. This provides the buyer with an independent and trusted inspection service, as well as assurance that the buyer will have recourse to an ongoing enterprise if there is any dissatisfaction. In other instances, the system offers a plurality of inspection services to the buyer. The buyer can choose the inspection service with which the buyer is most comfortable and initiate the inspection process.

In addition to a VIR, the system also offers the option of providing a vehicle history report, such as those provided by CARFAX or AutoCheck.

Listing and Advertising

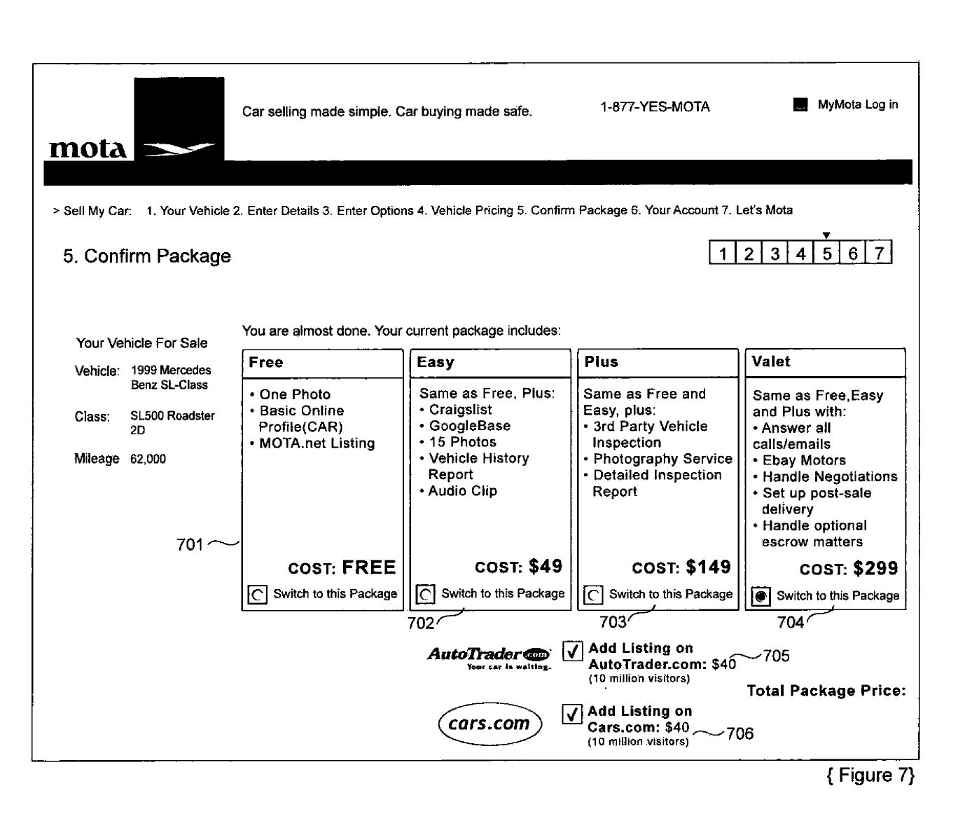

FIG. 7 illustrates one embodiment of the number of options that a seller can choose for listing and advertising using the system. The system provides in this embodiment four options 701, 702, 703, and 704. Option 701 is free to the seller in one embodiment and includes the right to include one image of the vehicle, the profile as generated by the interactive question process, and a listing on a vehicle listing service provided by the system (e.g. www.mota.com). Option 102 in this embodiment is an option that includes a fee for the seller (as do options 703 and 704). Option 702 includes additional listings (e.g. Craigslist and Autotrader, eBay motors, Yahoo, and the like) as well as the right to include up to fifteen images. This option 702 includes all options of the earlier option 701 plus a vehicle history report and an audio clip.

The audio clip is a sound file that is included with the online listing of the vehicle. The seller is prompted to record a sound file describing the car but answering the highest frequency questions that buyers typically have about vehicles, particularly the vehicle on sale. Even with the extensive data gathered from the seller and made available to potential buyers, there are still questions that the buyer wishes to hear discussed by the seller. The system anticipates this need and prompts the seller to answer these questions in a recorded voice file. The voice file is attached to the listing and potential buyers can choose to listen to it if desired. The goal of each listing is to reduce the need for the buyer to have direct communication with the seller for as deep into the process as possible. In this manner, the seller will only deal with actual potential buyers, avoiding the annoyance of dealing with multiple people.

Option 703 includes a third party vehicle inspection that a buyer can access either for free or for a relatively nominal fee, at the user's discretion. This option 703 also includes a professional photography service that come to the seller, takes professional photographs for use in the listing, and selects the best photographs to lead to a sale. This option 703 also includes a detailed inspection report.

Option 704 is the top option in this embodiment. This option provides a service where the system handles all communications with buyers. This eliminates the risk to the seller of visits or communications by strangers. It also includes listing on additional services (e.g. eBay motors).

Regardless of the option selected, the seller has the ability to choose additional listing media such as AutoTrader.com 705 and Cars.com 706 for additional fees.

Tracking and Management

The system provides the ability to track and manage the sale of the vehicle so that effort by the seller is reduced. The system can handle email inquiries about the vehicle and forward them to the seller. This prevents the buyer from having access to the seller's personal information. When the system call handling option is selected, the seller is insulated from all buyer communication, even after the sale is completed. This eliminates one of the prime prior art disadvantages of peer-to-peer vehicle sales, namely the discomfort and potential danger of interaction with and communication with strangers.

The system also provides other management operations. For example, in one embodiment, the system can track counteroffers to the sales price selected by the seller (if permitted). The system can compare these counteroffers to the selling price and make recommendations for adjusting the selling price. In addition, the system can track sales of similar vehicles in similar geographic areas and inform the seller of real world selling prices that may cause the seller to adjust the price (up or down).

Buyer

The buyer experience is also improved with the system. Some of the disadvantages of prior art peer-to-peer transactions from the buyer standpoint include lack of trustworthiness in the condition of the vehicle, lack of accessibility to the seller, inability to inspect the vehicle, lack of availability of financing, insurance, and warranty, and lack of recourse after a sale. The system provides improvements and solutions for all of these buyer disadvantages.

The buyer experience is in part defined by the options that the seller has selected and in part by the options that the buyer chooses to take advantage of. When the seller has selected the highest option level, the buyer is provided with the maximum amount of information about the vehicle including multiple images taken by a third party, a vehicle history report, and a VIR.

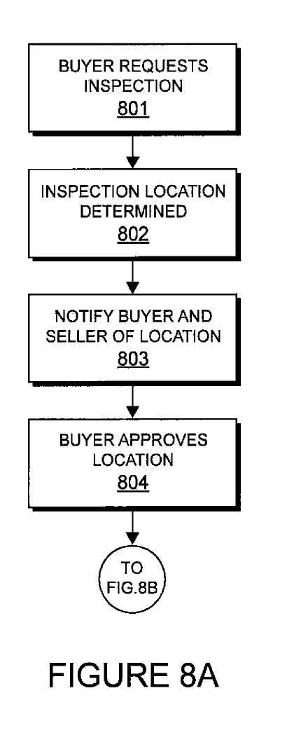

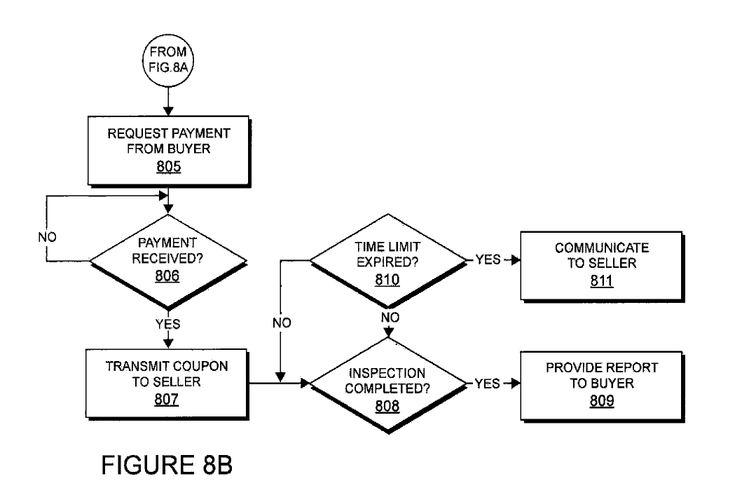

FIG. 8 is a flow diagram illustrating an embodiment of the system where a potential buyer requests an inspection of a vehicle. At step 801 a buyer indicates that an inspection is requested. At step 802 the system determines available inspection locations near the seller. The inspection location may be one pre-selected by the seller or may be an inspection location already in a partner relationship with the system and near the seller. (In one embodiment of the system, partnerships are formed with regional or national repair and parts centers, such as Pep Boys, Sears Automotive, Aamco, and others). After an inspection location has been determined, the system notifies the seller at step 803 of the inspection location. If the buyer approves the inspection location at step 804, the system requests payment from the buyer at step 805.

At decision block 806 the system determines if the payment has been received. If not, the system returns to step 805. If so, the system transmits a coupon to the seller at step 807. The coupon covers the expense of obtaining the vehicle inspection at the selected inspection location. The coupon also instructs the inspection location to forward a copy of the inspection results to the buyer at a provided address, or to the system via electronic transfer. The seller is encouraged to obtain the inspection quickly. The system sets a time limit within which the seller must schedule the inspection. At decision block 808 the system determines if the seller has had the car inspected. If so, the system provides the inspection report to the buyer at step 809.

If the seller has not had the vehicle inspected, the system proceeds to decision block 810 and checks to see if the time limit for inspection has expired. If not, the system returns to step 808. If so, the system proceeds to step 811 and communicates to the seller that the deadline has passed. In one embodiment, the seller need only make the vehicle available and a system representative will transport the vehicle to the inspection location.

Self Warranting

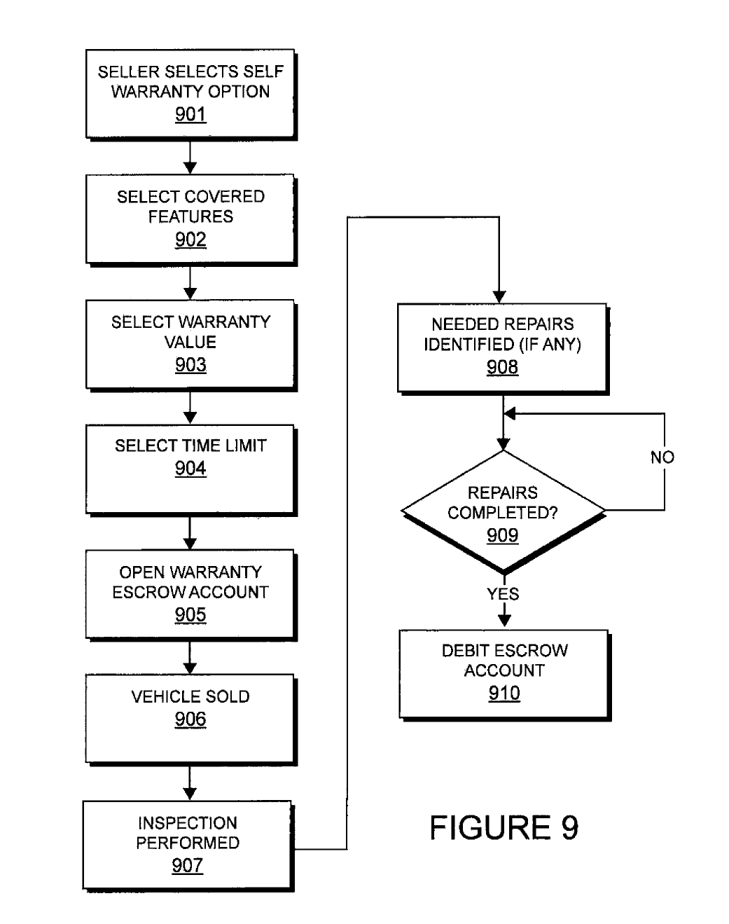

In one embodiment of the system, the seller designates in the sellers listing that the seller will self warrant the vehicle. This is to remove the need to have an inspection performed prior to sale and to facilitate more rapid turnaround from listing to sale. The seller will provide disclosure of possible problems and identify certain items on the vehicle that the seller will warrant. In the flow diagram of FIG. 9, the seller chooses self warranty at step 901. At step 902 the seller selects those features of the vehicle to be covered by the warranty. At step 903 the seller selects the total amount of warranty value (e.g. $2,000.00) and at step 904 the time limit of the warranty (e.g. 3 days). At step 905 the system creates an escrow account for the warranty amount to be held for the time limit of the warranty.

At step 906 the vehicle is sold to a buyer and the buyer receives the warranty and a coupon for an inspection at an approved inspection location. The buyer then has the inspection performed at step 907. At block 908 the report indicates repairs necessary on the vehicle. At decision block 909 it is determined if any of the indicated repairs are covered by the warranty. If so, at step 910 the escrow account is debited for those items up to the total warranty (optionally minus a deductible amount, e.g. $500.00). The remainder, if any, of the escrow amount is returned to the seller. If none of the indicated repairs are covered by the warranty, the escrow amount is returned to the seller and the transaction is complete.

The advantage to the seller of providing a self warranty is that the seller is in the best position to know the reliability and condition of the vehicle. At the same time, the escrowed warranty amount takes the question of trust out of the hands of the buyer. A buyer is not incentivized to get a car inspection when the buyer is not sure if they will be the successful bidder. The self-warranty option means that only the winning bidder needs to pay for an inspection and yet has a source of compensation if things are not as they are described.

Complete Transaction

The system also provides additional features that fill in the gaps between a commercial transaction and a peer-to-peer transaction. The system provides a way to refer customers to third party providers who may handle paperwork, title transfer, transport of the vehicle (if needed), financing, insurance, and post-sale continuing warranty.

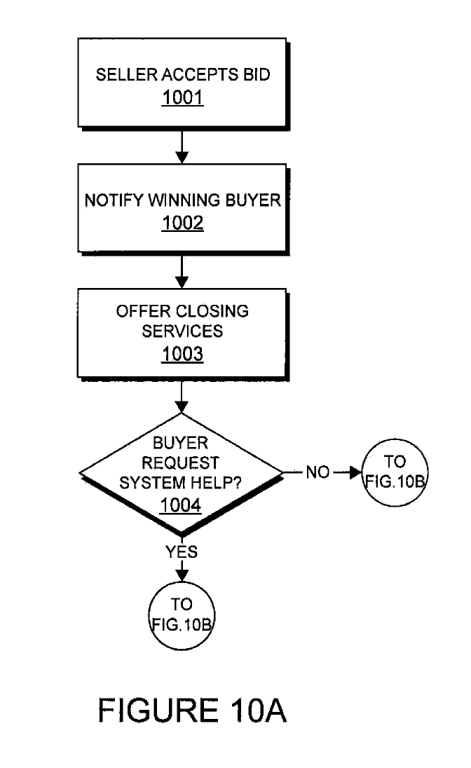

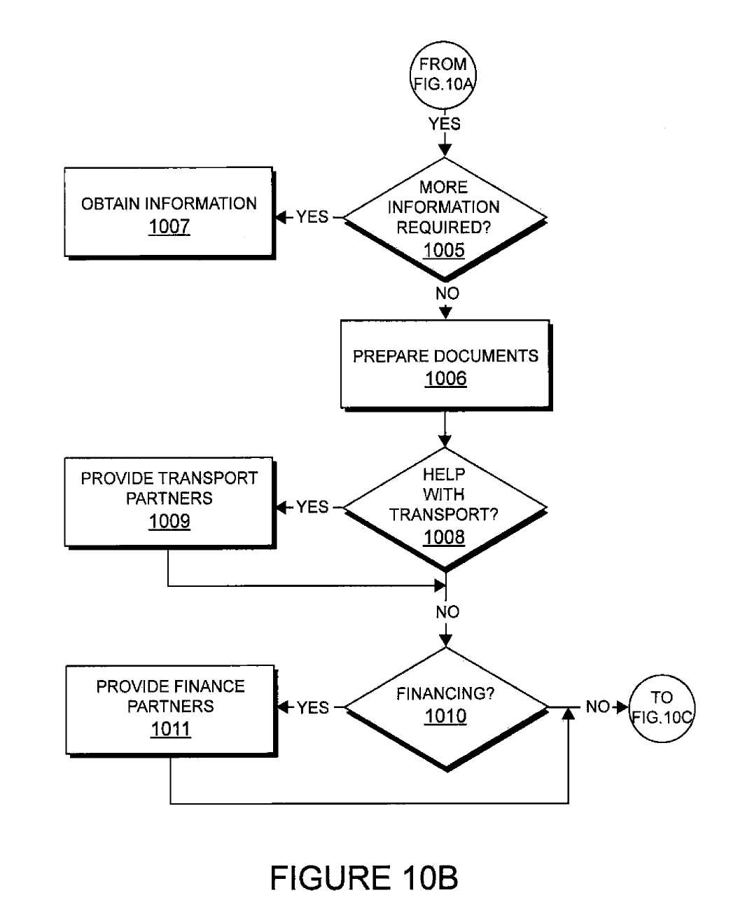

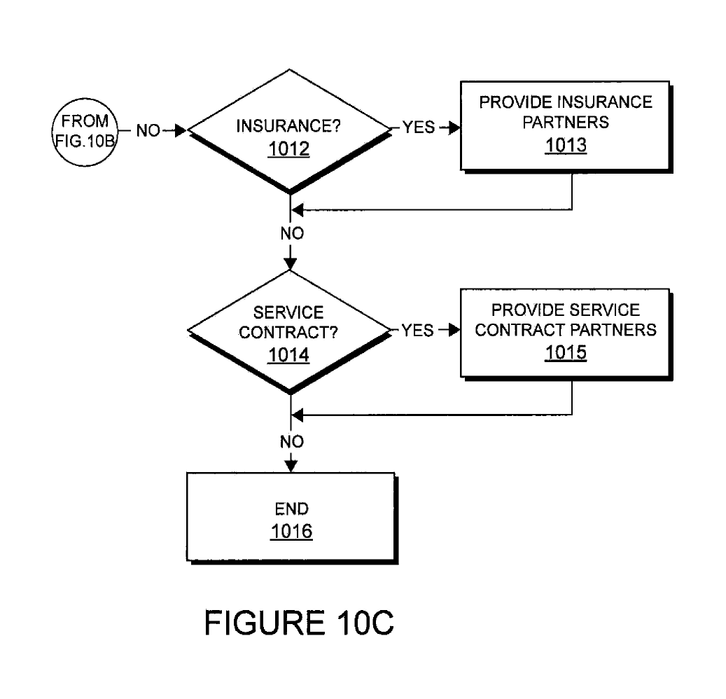

FIG. 10 is a flow diagram illustrating how the system operates at the close of a transaction. At step 1001 a seller accepts a bid which ends the selling part of the process. At step 1002 the system notifies the buyer that they buyer has won the bid and can now transfer ownership of the vehicle. At step 1003 the system offers the buyer the opportunity to participate in a number of closing services offered by the system. At decision block 1004 it is determined if the buyer wants the system to handle the paperwork of the transaction. If so, the system checks at decision block 1005 if it has the necessary information to prepare the transfer documents. If so, the system proceeds to prepare the transfer documents at step 1006.

If the system needs information at step 1005, it requests data from the buyer at step 1007 and then proceeds to step 1006. If the buyer does not want assistance with the paperwork at step 1004 or after step 1006, the system determines if the buyer needs assistance from a third party provider with the transport of the vehicle at step 1008. If so, the system provides the buyer at step 1009 with the opportunity to contract with a third party provider for transport of the vehicle.

If not, the system proceeds to step 1010 to determine if the buyer needs financing to complete the transaction. If so, the system includes financing options and initiates the financing process at step 1011. If the buyer does not need financing at step 1010, the system proceeds to step 1012 to determine if the buyer needs vehicle insurance. If so, the system offers at step 1013 insurance options from system partners. If not, the system determines at step 1014 if the buyer is interested in a continuing warranty on the vehicle. If the buyer desires a warranty, at step 1015 the system provides options from system partners. If not, the system exits at step 1016 and the sale is concluded as described below.

If the buyer does not want to take advantage of the services offered by the system or from third party providers, the buyer can complete the transaction under the terms established by the seller. The seller can require a particular form of payment (e.g. cashier's check, certified check, wire transfer, cash, etc). The seller may also wish to remain out of contact with the buyer and have transactions finalized by system representatives or third party providers. If the seller handles it personally, the system allows the buyer and seller to be in communication through the system through non-system channels as desired.

Repair Procedure

As noted above, there are a number of options for the buyer or seller to have the vehicle inspected and have a vehicle inspection report prepared. In some embodiments, the buyer or seller pays for the inspection and/or the report. In other embodiments, the inspection may be underwritten by a system sponsor in return for promotional placement on the system. Regardless of how the inspection report is funded, the system contemplates a novel method of acting on the inspection report.

The system provides a method for distributing the inspection report to qualified participating repair facilities. The repair facilities can review the report and provide estimates for some or all of the repairs indicated in the report. These estimates can be collected and presented to the users of the system and the buyer and seller can use the estimates to modify the price, to choose one or more facilities to do some or all of the recommended repairs, or to use as a basis for a warranty escrow account as described above. In one embodiment, the seller may arrange for inspection and submission of the report for repair bids prior to listing the vehicle for sale. This enables the seller to more accurately estimate a price or to have some of the repairs undertaken in the hopes of getting a greater increase of the price for the vehicle than the cost of the repair.

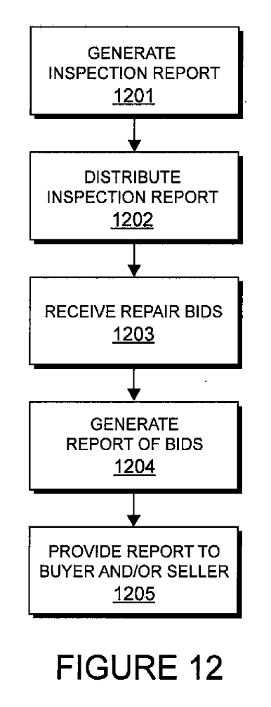

FIG. 12 is a flow diagram illustrating the operation of the repair flow of the system. At step 1201 the inspection report for a vehicle is generated. At step 1202 the inspection report is submitted to participating repair facilities. At step 1203 the repair facilities submit estimates for those repair that they are willing to undertake and perform. At step 1204 the estimates are collected and a report is generated that lists the recommended repairs along with the estimates and identities of the repair facilities for each item. At step 1205 the estimate report if provided to the buyer and/or seller as appropriate.

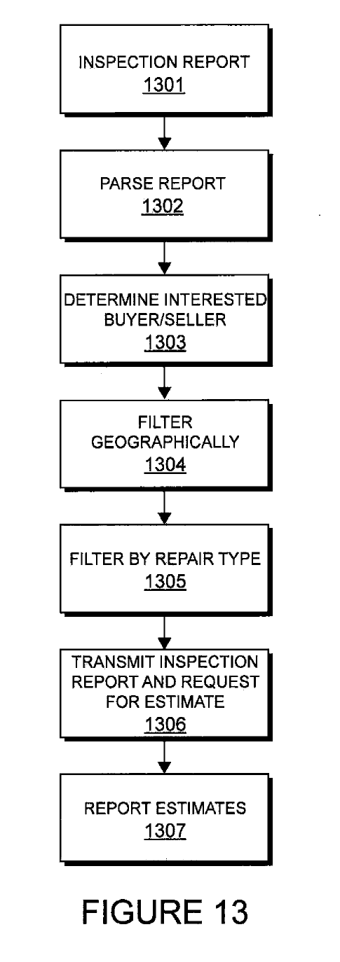

The determination of how to distribute the inspection report is described in more detail connection with the flow diagram of FIG. 13. At step 1301 an inspection report is received by the system. At step 302 the report is parsed and/or the metadata is analyzed to determine what repairs have been recommended. (This can be accomplished by having the inspection report identify each recommended repair by an industry or insurance accepted repair code.) At step 1303 it is determined if the buyer and/or seller is interested in receiving estimates for repairs. At step 1304 the database of participating repair centers is filtered to identify only those repair facilities in the geographic region of the buyer and/or seller. This geographic limitation may be tied to preferences of the buyer/seller such as how many miles away they would be willing to go to a repair facility.

At step 1305 the geographically qualified repair facilities are further filtered by the type of repair and the make/model/year of the vehicle under consideration. Some facilities may prefer to repair only certain types of vehicles (e.g. European, Japanese, American, German, Italian, etc.) or may only do certain types of repairs (e.g. body work, electrical, brakes, mufflers, tires, alignment, and the like). The results of this filtering step generates qualified repair facilities for this particular vehicle.

At step 1306 the inspection report is forwarded to the qualified repair facilities and they are each requested to bid on the recommended repair. This transmission may be of the entire report or only those portions of interest to the qualified repair facility. The request form may be generated by the system and have metadata identified fields that permit easy sorting and report generation. At step 1307 the repair facility returns its estimate for the recommended repairs.

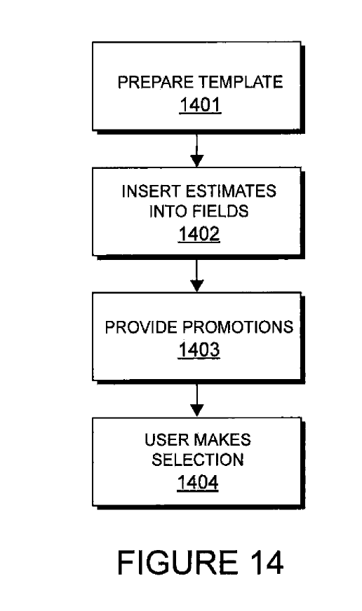

After the system receives the estimates, they are collected into a report for the customer (buyer/seller) as shown in FIG. 14. At step 1401 the system prepares a repair estimate template for the user. The template is populated by the appropriate fields based on the particular repairs from the inspection report. The system uses metadata identified fields, such as XML fields, to permit the easy sorting and generation of the appropriate report.

At step 1402 the estimate for each repair, along with the identity of the repair facility, is added to the report at the appropriate location, next to the recommended repair. These estimates may be sortable by the user based on a number of factors. For example, the estimates may be sortable from lowest to highest, by geographical location, by customer rating of the repair facility, and the like. In another embodiment, the system can present the estimates based on relationships between the system and the repair facility, such as advertising, promotion, and the like.

At step 1403 the user may be offered some premium or promotion by certain of the repair facilities if the user agrees to take some action. This action may be permitting the repair facility to contact the user directly to discuss the repair or it may be by selecting the repair facility to perform one or more repairs.

At step 1404 the user makes any selections of repair facilities for contact or performance related to the repairs.

REZA, DO YOU HAVE ANY SCREEN SHOTS OF THE ESTIMATE TEMPLATE AND/OR PRESENTATION?

Embodiment of Computer Execution Environment (Hardware)

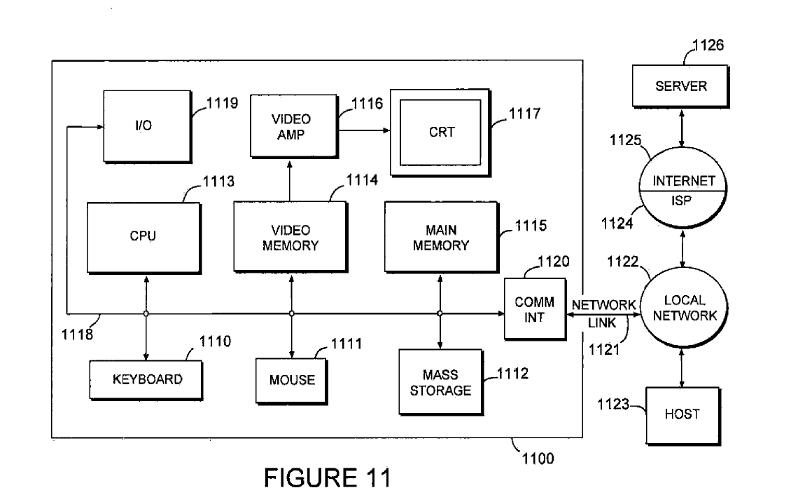

An embodiment of the system can be implemented as computer software in the form of computer readable program code executed in a general purpose computing environment such as environment 1200 illustrated in FIG. 11, or in the form of bytecode class files executable within a Java™ run time environment running in such an environment, or in the form of bytecodes running on a processor (or devices enabled to process bytecodes) existing in a distributed environment (e.g., one or more processors on a network). The system may also be implemented on any suitable computing device such as a PDA, mobile phone, mobile computing device, as a software service hosted on a server, an ethereal network based implementation, or any other suitable processing environment.

In the system of FIG. 11, a keyboard 1210 and mouse 1211 are coupled to a bidirectional system bus 1218. The keyboard and mouse are for introducing user input to the computer system and communicating that user input to central processing unit (CPU) 1213. Other suitable input devices may be used in addition to, or in place of, the mouse and keyboard 1210. I/O (input/output) unit 1219 coupled to bidirectional system bus 1218 represents such I/O elements as a printer, A/V (audio/video) I/O, etc.

Computer 1200 includes a video memory 1214, main memory 1215 and mass storage 1212, all coupled to bi-directional system bus 1218 along with keyboard 1210, mouse 1211 and CPU 1213. The mass storage 1212 may include both fixed and removable media, such as magnetic, optical or magnetic optical storage systems or any other available mass storage technology. Bus 1218 may contain, for example, thirty-two address lines for addressing video memory 1214 or main memory 1215. The system bus 1218 also includes, for example, a 32-bit data bus for transferring data between and among the components, such as CPU 1213, main memory 1215, video memory 1214 and mass storage 1212. Alternatively, multiplex data/address lines may be used instead of separate data and address lines.

In one or more embodiments of the invention, CPU 1213 is a microprocessor manufactured by IBM, Intel, AMD, Sun Microsystems or any other manufacturer. However, any other suitable microprocessor or microcomputer may be utilized. Main memory 1215 is comprised of dynamic random access memory (DRAM).

Video memory 1214 is a dual-ported video random access memory. One port of the video memory 1214 is coupled to video amplifier 1216. The video amplifier 1216 is used to drive the cathode ray tube (CRT) raster monitor 1217. Video amplifier 1216 is well known in the art and may be implemented by any suitable apparatus. This circuitry converts pixel data stored in video memory 1214 to a raster signal suitable for use by monitor 1217. Monitor 1217 is a type of monitor suitable for displaying graphic images.

Computer 1200 may also include a communication interface 1220 coupled to bus 1218. Communication interface 1220 provides a two-way data communication coupling via a network link 1221 to a local network 1222. For example, if communication interface 1220 is an integrated services digital network (ISDN) card or a modem, communication interface 1220 provides a data communication connection to the corresponding type of telephone line, which comprises part of network link 1221. If communication interface 1220 is a local area network (LAN) card, communication interface 1220 provides a data communication connection via network link 1221 to a compatible LAN. Wireless links are also possible. In any such implementation, communication interface 1220 sends and receives electrical, electromagnetic or optical signals which carry digital data streams representing various types of information.

Network link 1221 typically provides data communication through one or more networks to other data devices. For example, network link 1221 may provide a connection through local network 1222 to host computer 1223 or to data equipment operated by an Internet Service Provider (ISP) 1224. ISP 1224 in turn provides data communication services through the world wide packet data communication network now commonly referred to as the “Internet” 1225. Local network 1222 and Internet 1225 both use electrical, electromagnetic or optical signals which carry digital data streams. The signals through the various networks and the signals on network link 1221 and through communication interface 1220, which carry the digital data to and from computer 1200, are exemplary forms of carrier waves transporting the information.

Computer 1200 can send messages and receive data, including program code, through the network(s), network link 1221, and communication interface 1220. In the Internet example, server 1226 might transmit a requested code for an application program through Internet 1225, ISP 1224, local network 1222 and communication interface 1220. In accord with the invention, one such downloaded application is the method and apparatus for creating, editing and displaying works containing time-dimensioned textual components described herein.

The received code may be executed by CPU 1213 as it is received, and/or stored in mass storage 1212, or other non-volatile storage for later execution. In this manner, computer 1200 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the system may be implemented in any type of computer system or programming or processing environment.

Thus, a method and apparatus for peer-to-peer sales is provided.

What is claimed is:

1. A method for providing vehicle repair comprising:
generating an inspection report specifying repairs for a vehicle;
distributing the inspection report to a plurality of repair shops through a computer network;
receiving a plurality of repair bids from the plurality of repair shops through the computer network,
generating a report of the plurality of bids;
providing the report to a customer.

2. The method of claim 1 wherein the customer selects one of the repair bids and has the vehicle repaired pursuant to the selected bid.

3. The method of claim 2 wherein the customer is a seller of a vehicle.

4. The method of claim 2 wherein the customer is a buyer of a vehicle.

5. The method of claim 1 wherein the plurality of repair shops is filtered to be within a threshold geographical distance from the customer.

6. The method of claim 1 wherein the plurality of repair shops is filtered by repair type specialization of the plurality of repair shops.
